(19) United States
(12) Patent Application Publication
(10) Pub. No.: US 2005/0050086 A1
(43) Pub. Date: Mar. 3, 2005

(54) Apparatus and method for multimedia object retrieval

(75) Inventors: Jinsong Liu, Beijing (CN); Hao Yu, Beijing (CN); Fumihito Nishino, Kanagawa (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/913,514

(22) Filed: Aug. 9, 2004

(30) Foreign Application Priority Data
Aug. 8, 2003 (CN) 03153179.2

(51) Int. Cl. G06F 17/00

(52) U.S. Cl. 707/102

(57) ABSTRACT

A multimedia object retrieval apparatus and method for retrieving multimedia objects from structured documents containing both a multimedia object and relevant explanation text. The apparatus and method parse an input structured document into a parsing result such as an HTML DOM tree; recognize a main block in the input parsing result and output a main block annotated structured document model; extract a pair of a multimedia object and corresponding explanation, and output a structured object index such as an XML format object index; and search through the structured object index to form a target object list. The apparatus and method can be applied to various kinds of structured documents, and can extract object explanations with a high precision. The apparatus and method may also identify the relationship between the object and the title of the input structured document.

### CLAIM TO PRIORITY AND RELATED APPLICATION

This application is based on and claims priority to Chinese Patent Application No. 03153179.2, filed Aug. 8, 2003, the contents of which are incorporated herein by reference.

### FIELD OF THE INVENTION

The present invention relates to an apparatus and method for analyzing explanations of multimedia objects such as image, animation, video, audio and table objects from structured documents such as web pages, XML files and newspapers.

### DESCRIPTION OF RELATED ART

The development of Internet technology makes it easy and profitable to distribute commercial multimedia objects, such as images, music and movies, on the Internet. On the other hand, Internet technology also makes it convenient to illegally copy and redistribute these commercial multimedia objects. Now such illegal copies can be found almost everywhere on the WWW, thus sharply reducing the profits of legal commercial activities. Thus it is strongly demanded to develop an internet policing system to find out these illegal objects. An image retrieval system is an example of a typical object retrieval system.

Since the 1970s, image retrieval has been a very active research area. One method is primarily text-based (see Anna Bjarnestam, 1998, Text-based Hierarchical Image Classification and Retrieval of Stock Photography, The Challenge of Image Retrieval Conference, Feb. 25-26, 1999, Newcastle upon Tyne, UK). Another method relies on visual properties such as the color, texture and shape of the data, and is referred to as content-based image retrieval (see Eakins, J. P. and Graham, M. E., 1999, Content-Based Image Retrieval, Report to JISC Technology Applications Programme, January 1999).

Besides being laborious and time consuming, a deficiency of both of these two methods is that they do not take advantage of the format of web pages. Furthermore, a survey of users attempting image retrieval shows that they are much more interested in the identification of images and actions depicted by images than with the color, shape, and other visual properties that most content-based retrieval systems provide (see C. Jorgensen, 1998, Attributes of Images in Describing Tasks, Information Processing and Management, vol. 34, No. 2/3, pp. 161-174).

Another survey of random Web photographs shows that 93% have more than one caption, and only 7% have no visible caption (see Neil C. Rowe, 1999, Precise and Efficient Retrieval of Captioned Images, The MARIE Project).

Thus, scholars are recently getting more and more interested in web-based image retrieval. They use elements such as metadata, HTML title, image URL, alternate text and anchor text combined with graphical features to retrieve images from the WWW (see Rong Zhao and William I. Grosky, 2002, Narrowing the Semantic Gap—Improved Text Based Web Document Retrieval Using Visual Features, IEEE Transactions on Multimedia, 4(2), pp. 189-200, 2002).

Good results have been achieved and commercial image retrieval systems have been built up—for example, Google.

FIG. 1 is a block diagram of a conventional object retrieval system. The input is a structured document 101, such as a web page. First, the system parses the input structured document 101 with a simple parsing unit 102, then an explanation extracting unit 104 extracts the explanations for each multimedia object from the parsing result 103 output from the parsing unit 102, simply by calculating the distance between the multimedia object and the text, and a multimedia object index 105 is output as a result. Finally, a multimedia object retrieval unit 106 compares the multimedia object index 105 with a retrieval requirement 107 input by the user, and returns a target object list 108.

So, it can be seen that there are some deficiencies existing in the traditional object retrial system.

First, traditionally an object's explanation is extracted by calculating the distance between the object and text. If the distance is less than a critical value, then the text is set as the explanation of related object, otherwise it is not set at all. This algorithm is too simple in that it throws away a lot of useful information, thus resulting in a low performance of the current object retrieval system. Further, it is very common that a web page contains a Main Text Block or Repeating Object Block (referred to as Main Block hereinafter). If we can identify the Main Block of a page before extracting the explanation of a multimedia object, the efficiency of the object retrieval can be significantly improved.

Second, it is obvious that the HTML Title often has some kind of relationship to the objects in the page. But the HTML Title may only be related to some of the objects within the page, rather than to all the objects. Since the traditional multimedia object retrieval system doesn't make detailed analysis of the structure of a web page, it cannot distinguish the related objects from the unrelated objects. Either the Title is set as an explanation to all the objects, or it is not set at all, which is inadequate. If the Main Block can be identified, we can set the Title as an explanation to the objects in the Main Block only, thus the system's performance can be improved.

Third, in a page containing more than one content object, there are usually Common Explanations which describe the common content of all objects besides explanations of each individual image, while it's impossible for the traditional systems to deal with such a case. If we can identify the Main Text Block and a Repeating Object Block, we can classify the explanation into an Individual Explanation and a Common Explanation, and extract them respectively, thus the performance of the system can be significantly improved.

### SUMMARY OF THE INVENTION

Additional aspects and/or advantages of the invention will be set forth in part in the description which follows and, in part, will be obvious from the description, or may be learned by practice of the invention.

An object is to solve the problems existing in the prior art multimedia object retrieval, and to provide an apparatus and method for analyzing the explanations of multimedia objects such as images, animations, video, audio, tables, etc., from structured documents such as web pages, XML files, newspapers, and the like.

In an aspect of the invention, there is provided a multimedia object retrieval apparatus for retrieving multimedia objects from structured documents containing both a multimedia object and relevant explanation text, comprising a parsing unit for parsing the input structured document into a parsing result of a particular form; a main block recognition unit for recognizing a main block in the input parsing result and outputting a main block annotated structured document model; an object explanation extraction unit for extracting a pair of the multimedia object and the corresponding explanation from the main block annotated structured document model, analyzing the explanation of the multimedia object, extracting the key words that actually explain the contents of the multimedia object, canceling invalid explanations, and outputting a structured object index of a particular form; and a multimedia object retrieval unit for searching through the structured object index, and forming a target object list.

The multimedia object retrieval apparatus of the present invention may further include a common explanation extraction unit for extracting a common explanation for each multimedia object in respective main blocks according to a common explanation extraction rule.

In another aspect of the invention, there is provided a multimedia object retrieval method for retrieving multimedia objects from structured documents containing both a multimedia object and relevant explanation text, the method including parsing the input structured document into a parsing result of a particular form; recognizing a main block in the input parsing result and outputting a main block annotated structured document model; extracting a pair of the multimedia object and the corresponding explanation and outputting a structured object index; and searching through the structured object index to form a target object list.

The multimedia object retrieval method of the invention may further include extracting a common explanation for each multimedia object in respective main blocks with a common explanation extraction rule.

The main block of the invention may include a main text block or a repeating object block.

The apparatus and method of the invention can be applied to almost all kinds of structured documents. By recognizing the Main Text Block and Repeating Object Block to extract an explanation, we can not only extract an object's explanation with a higher precision, but we also can recognize the Common Explanation of a group of objects and identify the relationship between the multimedia object and the structured document's title. With the apparatus and method of the present invention, the performance of multimedia object retrieval can be significantly improved.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a traditional object retrieval system;

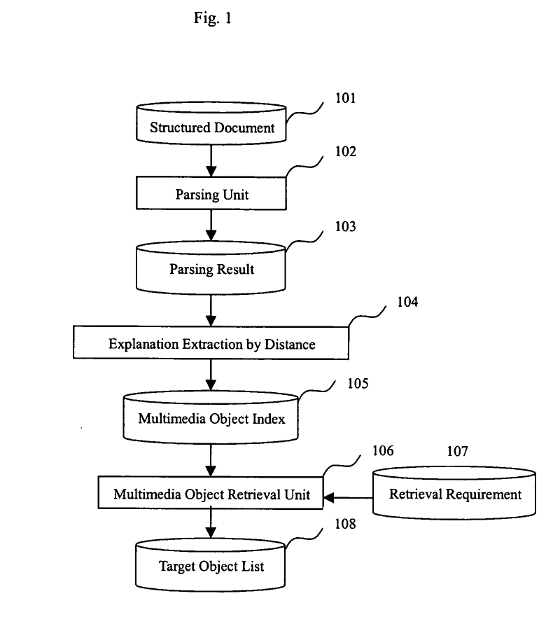

FIG. 2 is a block diagram of an object retrieval system of the present invention;

FIG. 3 is a block diagram of a Main Block Recognition unit;

FIG. 4 is a block diagram of a Main Text Block Recognition unit;

FIG. 5 is a block diagram of a Repeating Object Block Recognition unit;

FIG. 6 is a block diagram of an Object Explanation Extraction Unit;

FIG. 7 is a block diagram of an Object Retrieval Unit;

FIG. 8 is an example of an input web page which contains four kinds of Image Objects (an example of a multimedia object);

FIG. 9 is an example of an HTML DOM Tree (an example of a Parsing Result);

FIG. 10 is an example of a web page containing a Main Text Block;

FIG. 11 is an example of a web page containing a Repeating Image Block (an example of a Repeating Object Block);

FIG. 12 is an example of an HTML tag stream (an example of a structured document tag stream) of the Repeating Image Block (an example of the repeating object block); and

FIG. 13 is an example of an output XML format Object Index (an example of a structured object index) extracted from a web page (an example of the structured document).

### DETAILED DESCRIPTION OF THE PREFERRED EMBODIMENTS

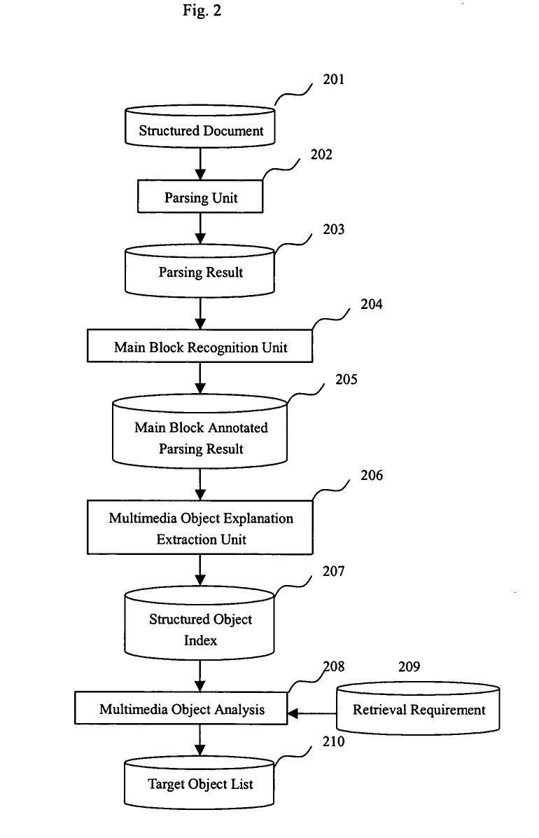

FIG. 2 is a block diagram of an object retrieval apparatus according to the present invention. The input of the apparatus is a Structured Document 201 such as a web page. First, the Parsing Unit 202 converts the input Structured Document 201 into some kind of Parsing Result 203 such as a DOM (document object model) Tree. Then the Main Block Recognition Unit 204 recognizes a Main Block of the Structured Document 201 from the Parsing Result 203 and outputs a Main Block Annotated Parsing Result 205. Then, a Multimedia Object Explanation Extraction Unit 206 extracts a pair of the multimedia object and corresponding explanation, and outputs a Structured Object Index 207 such as an XML Format Object Index. Finally, the Object Analysis Unit 208 determines whether the candidate object is a target object or not by comparing the Structured Object Index 207 with an Input Requirement 209, and returns a result in the form of the Target Object List 210.

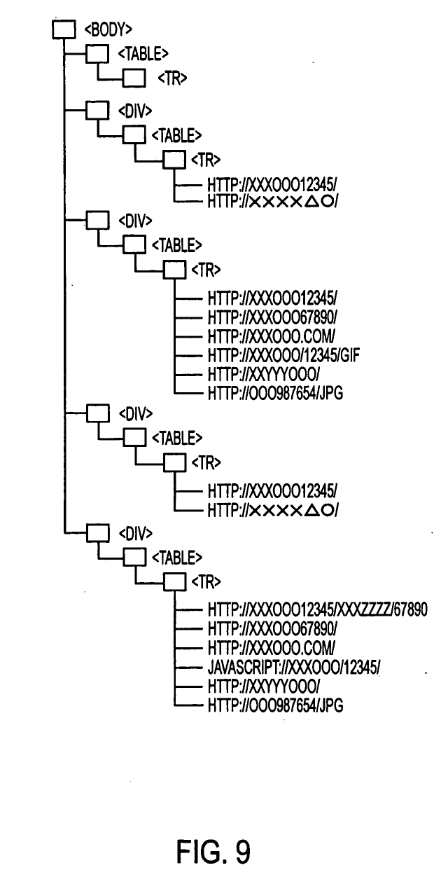

Since it is difficult to process the input Structured Document 201 such as HTML source code directly, a Parsing Unit 202 such as an HTML parser is developed, for representing the structured document 201 as some kind of Parsing Result 203, for example, an HTML DOM Tree, to make it convenient for the following processing. FIG. 9 shows an example of an HTML DOM Tree which is an example of the Parsing Result 203.

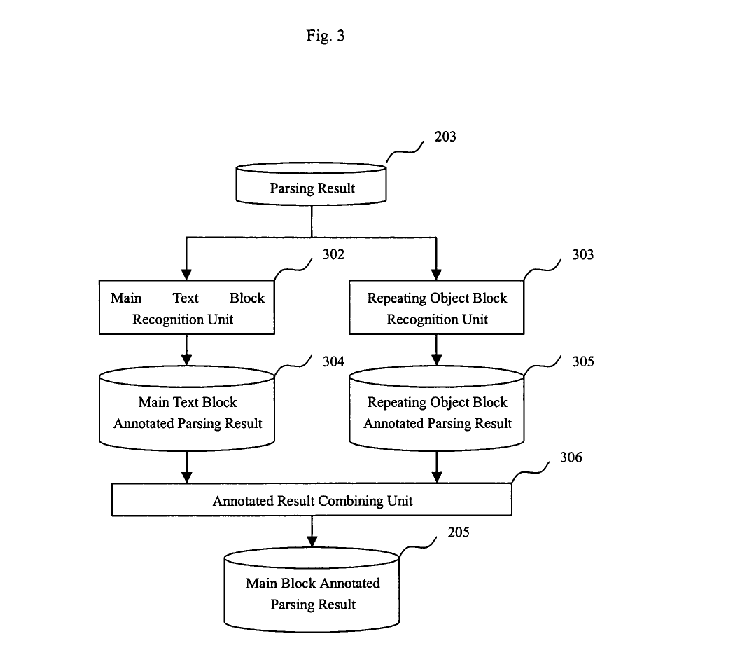

FIG. 3 shows the key steps for recognizing the Main Block of the input Structured Document 201. The Main Block Recognition Unit 204 may include a Main Text Recognition Unit 302 and a Repeating Object Block Recognition unit 303. First, the Input Parsing Result 203 is annotated respectively by the Main Text Block Recognition Unit 302 and the Repeating Object Block Recognition Unit 303. The output of the Main Text Block Recognition Unit 302 is a Main Text Block Annotated Parsing Result 304. The output of the Repeating Object Block Recognition Unit 303 is a Repeating Object Block Annotated Parsing Result 305. Subsequently, the Annotated Result Combining Unit 306 combines these two results into a Main Block Annotated Parsing Result 205, in which both the Main Text Block and the Repeating Object Block are annotated.

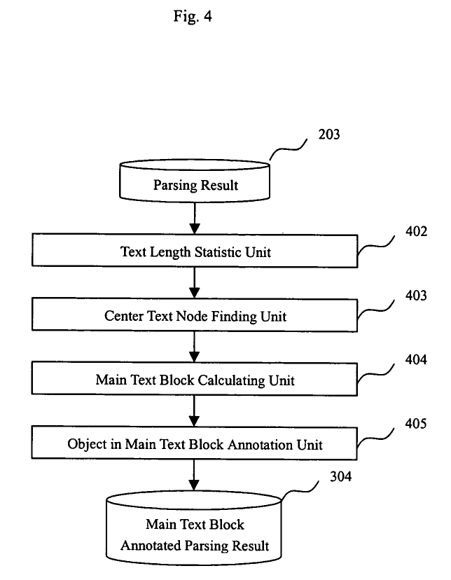

FIG. 4 shows the key steps for recognizing a Main Text Block. The input is the Parsing Result 203 output from the Parsing Unit 202. First, the text length of each node in the Parsing Result 203 is calculated by a Text Length Statistic Unit 402. Second, a center text node is located by a Center Text Node Finding Unit 403. Then the Main Text Block is recognized by a Main Text Block Calculating Unit 404. After the Main Text Block is recognized, multimedia objects in the Main Text Block are annotated by an Object in Main Text Block Annotation Unit 405. Thus a Main Text Block Annotated Parsing Result 304 is obtained.

In the Text Length Statistic Unit 402, the text length of each node in the Parsing Result 401 is calculated. The Text Length of a node is the length of its content when it is a text node, except when it is an invalid text node such as a declaration of copyright, in which case the length is considered zero. The punctuation in the content of the text node is first removed. If a node has sub nodes, the text length of that node is the total length of its sub nodes.

The Center Text Node Finding Unit 403 is used for finding the center text node of a node of the Parsing Result. Whether a node has center text node or not is determined by the following rules. First, if the text length of the node is less than a predetermined value LEAST_MAIN_BLOCK_LENGTH (for example 50), or it has no sub node at all, it cannot have a center text node. Second, as all sub nodes are traversed, if a sub node is a table and the ratio of the text length thereof to the text length of the node is larger than a predetermined value MAX_CENTER_NODE_RATE (for example 90%), or the text length thereof is larger than a predetermined value MAIN_BLOCK_LENGTH (for example 200) and the ratio of the text length of the sub node to that of this node is larger than a predetermined value LEAST_CENTER_NODE_RATE (for example 60%), then the node has a center text node, and the corresponding sub node is the center text node of the node.

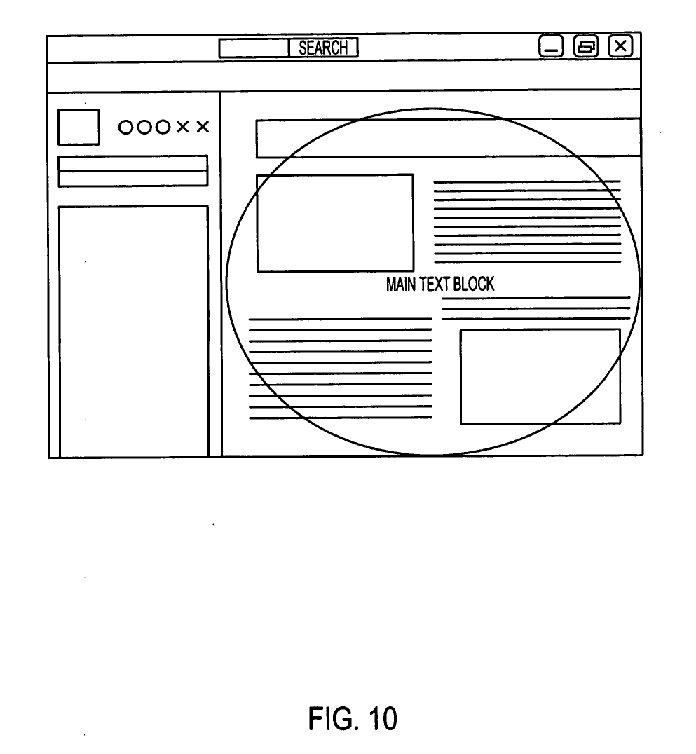

The Main Text Block is a text paragraph in a Structured Document 201 such as a web page for describing the main content of the input Structured Document 201. The Main Text Block is usually related to the title of the Structured Document 201. There are usually many multimedia objects set in such paragraphs, for helping to express the idea of the Structural Document 201 more clearly or make it more attractive to the reader. These multimedia objects are also often related to the title of the Structured Document 201. FIG. 10 is an example of the Main Text Block in a web page which is a kind of Structured Document 201.

Now reference will be made to the Main Text Block Calculating Unit 404. First, regarding the Text Length, we identify the Main Text Block mainly by Text Length. If the text is too short (the Text Length is less than a predetermined value LEAST_MAIN_TEXT_BLOCK_LENGTH) or it is a Link Text Block, then the text cannot be a Main Text Block. The Link Text Block is HTML DOM Tree (an example of a Parsing Result) node in which the link text length is more than a predetermined value LEAST_LINK_BLOCK_LENGTH (for example 30) and the text length is less than a predetermined value MAIN_BLOCK_LENGTH (for example 200), and the ratio of the link length to the total Text Length is larger than a predetermined value LINK_BLOCK_RATE (for example 80%). If the Text Length is larger than a predetermined value MAIN_TEXT_BLOCK_LENGTH (for example 200) or the ratio of the Text Length to the Text Length of the Root node is larger than a predetermined value MAIN_TEXT_BLOCK_RATE, it can be recognized as a Main Text Block. Second, regarding the Keyword, a text paragraph which is long enough and contains the Structured Document 201's Title such as an HTML Title is also tagged as a Main Text Block. Regarding the HTML section <body>, if no Main Text Block is recognized in the sub nodes, the <body> with a Text Length more than MAIN_TEXT_BLOCK_LENGTH will be set as the Main Text Block. Regarding the Direction, if we use these rules from top to bottom, the top tags will satisfy them very easily; however, such a process produces a nonsensical result, so we use these rules from bottom to top. When more than two sub nodes are recognized as a Main Text Block, the node is also a Main Text Block. If a node has a center text node, whether this node is a Main Text Block is equal to whether the center text node of this node is a Main Text Block.

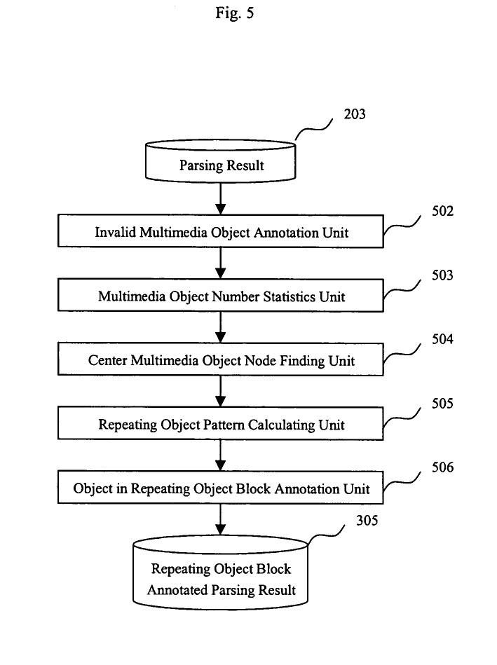

FIG. 5 shows the key steps of recognizing a Repeating Object Block. The input is some kind of Parsing Result 203, such as an HTML DOM Tree. First, the invalid objects are annotated by an object filtering unit such as the Invalid Multimedia Object Annotation Unit 502 of FIG. 5. Then, the Object Number Statistic Unit 503 counts the number of objects in each node within the Parsing Result 203. Further, the center object node of each node in the Parsing Result 203 such as an HTML DOM Tree node will be retrieved by a Center Object Node Finding Unit 504. After that, Repeating Object Blocks are identified by a Repeating Object Block Recognition Unit 505. Finally, the Object in Repeating Object Block Annotation Unit 506 makes a tag on each object in the Repeating Object Blocks. Thus a Repeating Object Block Annotated Parsing Result 305 is obtained.

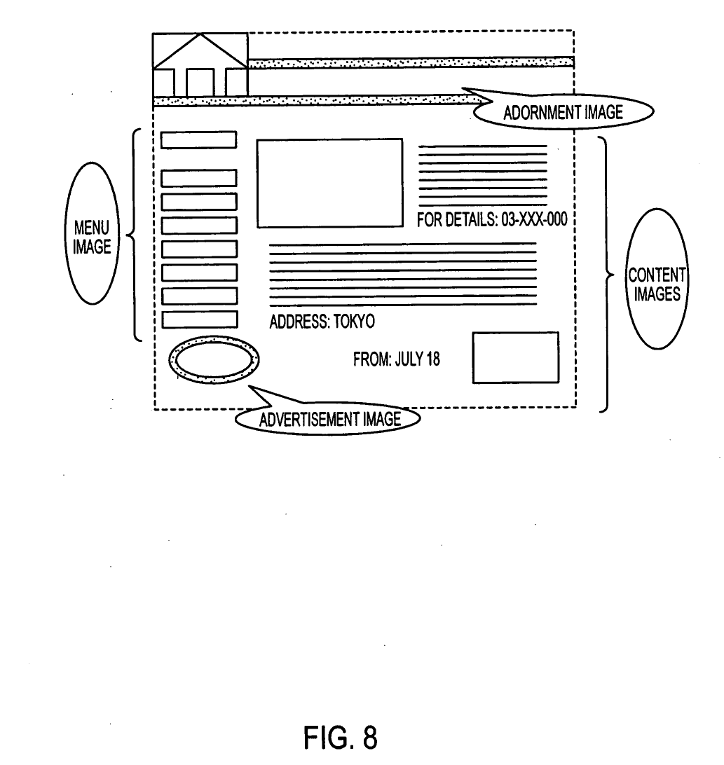

In the Invalid Multimedia Object Annotation Unit 502, invalid objects such as adornment images are annotated automatically. Objects in a web page can be classified into four categories: Content Object, Adornment Object, Menu Object and Advertisement Object. FIG. 8 shows an example of all these four kinds of objects. Content Objects include an explanation or are settled in a Main Text Block or Repeating Object Block. Adornment Objects are not related to the content of a web page; they are only for making the page look more beautiful and attractive to the user. Many adornment objects appear recursively. Many web pages have image menus (an example of the Menu Object) which include a list of objects. These objects have links pointing to other Structured Documents 201 such as web pages, subdirectory Structured Documents 201, and subdirectory web pages of a website. These objects are usually placed in the left most, or the top of the input Structured Document 201. There are usually many objects, the content of which is not relevant to the main idea of the web page, but pointing to other commercial websites. Such objects are referred to as Advertisement Objects.

Among all these four kinds of objects, only the Content Object is to be provided to the user by the Object Search Engine. So, the other three kinds of objects are classified as Invalid Objects. Both a Content Object and an Invalid Object cannot be clearly defined before the Explanation Field is extracted and the Main Block is identified. At first, we can only find some of the Adornment Objects by some characters such as an object's size and a recursive property. In the Invalid Object Annotation Unit 502, we can identify an Invalid Object according to following rules. Adornment Object: if an object is extremely long, that is, its height/width is less than a predetermined value RATE_OBJECT_TOO_LONG (for example 1/4), or is slim, that is, its height/width is larger than a predetermined value RATE_OBJECT_TOO_SLIM (for example 4), or the size is too small, that is, height width is less than a predetermined value SIZE_TOO_SMALL (for example 900), or it appears recursively, that is, appears more than one time, then this object is an Adornment Object. Other objects are temporarily set to be Candidate Objects. If an object's size is unknown, that is, both width and height are unknown, it is also set as Candidate Object.

The Object Number Statistic Unit 503 is used for counting the number of objects in each node within the Parsing Result 203, such as an HTML DOM Tree node. If a node is an object node and the object is a Candidate Object, the number of object is 1, otherwise it is 0. If a node has a sub node, the number of objects is the sum of the object numbers of each sub node.

The Center Object Node Finding Unit 504 is used for locating the Center Object Node of the current node. The Center Object Node is recognized according to the following rules: if a node has no object then it has no Center Object Node; if the ratio of the number of objects of a sub node to that of the current node is larger than a predetermined value MAX_CENTER_NODE_RATE (for example 90%), then it is the Center Object Node of this node.

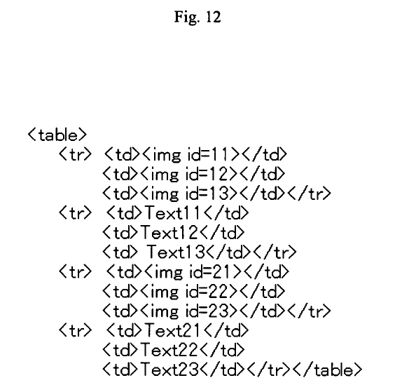

The Repeating Object Pattern Calculating Unit 505 recognizes a Repeating Object Pattern with the following rules. Object Number: if the number of objects in a node is less than 2, it cannot be a Repeating Object Block. Structured Document's tag: using an HTML Document as an example, if the node is not <body> or <table> or <tr>, then the node cannot be a Repeating Object Block. Sub node's HTML tag stream: here the DOM Tree node's tag stream includes a list of HTML tags retrieved by depth-first method. FIG. 12 shows an example: the HTML tag stream of this table node is
“<table> <tr> <td> <img> <td> <img> <td> <img> <tr> <td> <txt> <td> <txt> <td> <txt> <tr> <td> <img> <td> <img> <td> <img> <tr> <td> <txt> <td> <txt> <td> <txt>”.

<img> represents an image node of the DOM Tree, which is an example of the object node. <txt> represents a text node of the DOM Tree. And in this case we consider the tag <img> the same as the tag <txt>. If more than two sub nodes' tag streams are identical, we consider this node as a Repeating Object Block. If this node is a <table> node, the repeating pattern should be in a <Tr> sub node, and should contain more than one object or text. If this node is a <tr> node, the repeating pattern should be in <td>. The previous <table> node is a Repeating Object Block, because it is a <table> node and contains six objects in two rows. Its sub node has identical tag streams. Regarding Direction: differently from the direction of Main Text Block recognition, we identify the Repeating Object Block from top to bottom.

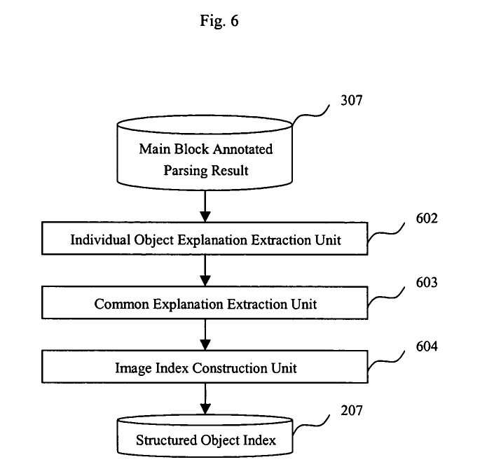

FIG. 6 shows the key steps of Object Explanation Extraction. The input is a Main Block Annotated Parsing Result 307 such as an HTML DOM Tree. The Individual Object Explanation Extraction Unit 602 extracts the Explanation of each Candidate Object. Then the Common Explanation Extraction Unit 603 extracts the Common Explanation of the Candidate Objects. The Object Index Construction Unit 604 creates the Structured Object Index 207 such as an XML format index 605 of all Content Objects.

The Individual Object Explanation Extraction Unit 602 extracts nine kinds of explanations of the Candidate Objects, including the Absolute Address of the Structured Document, for example a web page's URL; the Title of the Structured Document, for example a web page's Title; the Object's Filename; an Alternative Field; an Individual Explanation; a Common Explanation; a Surrounding; an indication of whether the object is in a main text block; and an indication of whether the object is in a repeating object block, according to the following rules.

Filename and Alternative Text: filename and alternative text are natural explanations of the Object; they are two properties of the object, and are specified by the Parsing Unit. Single HTML tag: if the object and text are located within a single Structured Document tag, for example in a single HTML tag, such as <A>,<td>, or <center>, then text is considered an explanation of the object. Object and text in a row: if the object and text are placed in a row, for example in separate <td> within a <tr>, the text is set as an explanation of corresponding object. Object and text in Repeating Object Block: if the object and text are located in a Repeating Object Block, then the explanation of the object will be extracted according to the repeating pattern. Taking FIG. 12 as an example, the node <table> is a Repeating Object Block. The repeating pattern is “<tr> <td> <img> <td> <img> <td> <img>” (note that we consider <txt> the same as <img>). So text11, text12, and text13 in row 2 are the explanations of image object11, image object12, and image object13, respectively. And text21, text22, and text23 in row 4 are the explanations of image object21, image object22, and image object23, respectively. All the texts extracted as an explanation are tagged as have been used and will not be extracted again in the following process.

If all the previous methods fail to locate the explanation of the object, we will extract an explanation by distance. Distance is calculated by the type of the Structured Document's tag, for example the type of HTML tag. Different tags have different distance values. Using distance is a common method to retrieve an object's explanation. If there are more than one candidate object and text in a single HTML tag or row, the explanation is also extracted by distance. Explanation extracted by distance is tagged as Surrounding.

Optionally, the Individual Object Explanation Extraction Unit 602 can include a Keyword Extraction Unit for analyzing the explanations for the multimedia objects, extracting the keywords actually accounting for the multimedia objects, and canceling invalid explanations, using a predetermined rule for analyzing actual explanation Keywords.

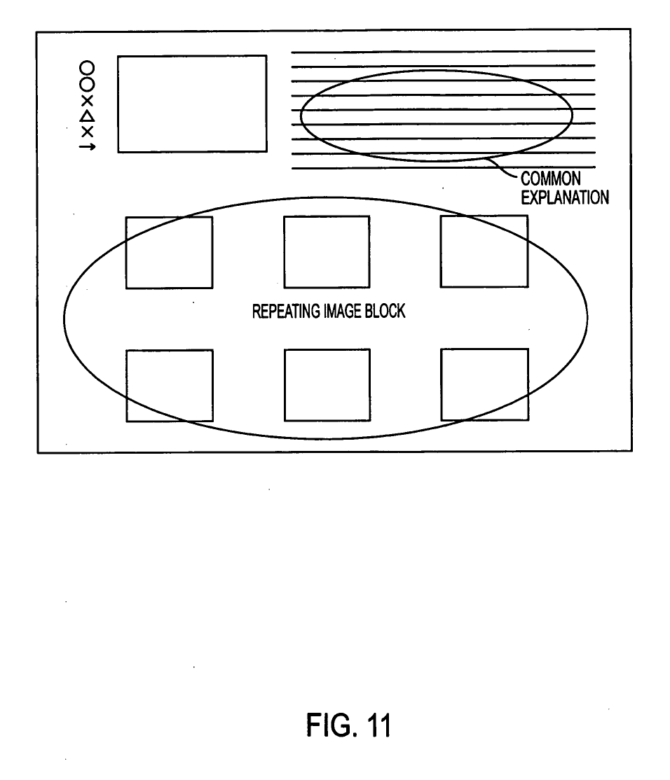

The Common Explanation Extraction Unit 603 extracts the Common Explanation of the Candidate Objects. A Common Explanation is another kind of object explanation which describes the contents of a group of objects instead of a single object. For example, the text within the black ellipse shown in FIG. 11 is an example of a Common Explanation. The text describes the contents of all the seven objects in this web page.

The Common Explanation is extracted according to the following rules. First, we traverse a Parsing Result, such as an HTML DOM Tree for a Main Text Block. If a Main Text Block contains a Candidate Object, then the text which has not been used and is tagged as an Explanation of the object is extracted, and when a node's tag stream is a Repeating Object Pattern, all texts in the node are neglected. This text is set as a Common Explanation of all Candidate Objects in this Main Text Block. Second, we traverse the HTML DOM Tree for a Repeating Object Block.

If a Repeating Object Block is found with text, all unused text and text out of a Repeating Pattern will be extracted as a Common Explanation. This text will be set as a Common Explanation of the Candidate Objects among the Repeating Pattern of this Repeating Object Block. If there is no text in the Repeating Object Block, we take the texts ahead of the Repeating Object Block as the Common Explanation, unless the previous node is another Repeating Object Block, Repeating Object Pattern, MultiNode or Candidate Object. A MultiNode is an HTML DOM Tree node which contains both Candidate Object and text.

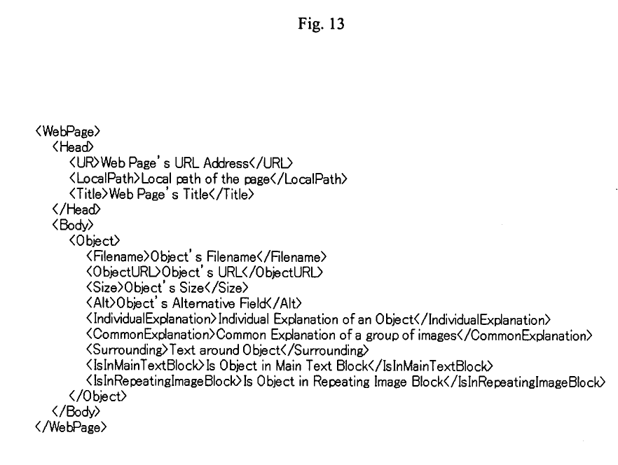

At this step, all explanations of Candidate Objects have been extracted. Now the Object Index Construction Unit 604 will create the Structured Object Index 207 such as an XML format index of all multimedia objects in the input Structured Document 201. FIG. 13 shows an XML format object index as an example of the Structured Object Index 207. All object's explanations are recorded between the tags <WebPage> and </WebPage>. The information on the whole page, including the web page's URL, the local path of the page, HTML Title and Total Number of Content Objects in the page, is recorded in the <head>. In the <Body>, there is a list of object tags which record the information on each object. The object's information includes an Object's Filename, an Object's Absolute URL Address, the size of the Object, an Alternative Field, Individual Explanation, Common Explanation, Surrounding, and an indication of whether the object is in a Main Block. When an Object is in a Main Text Block, the corresponding item <IsInMainTextBlock> is set to be true, while when the object is in a Repeating Object Block, the corresponding item <IsInRepeatingObjectBlock> is set to be true.

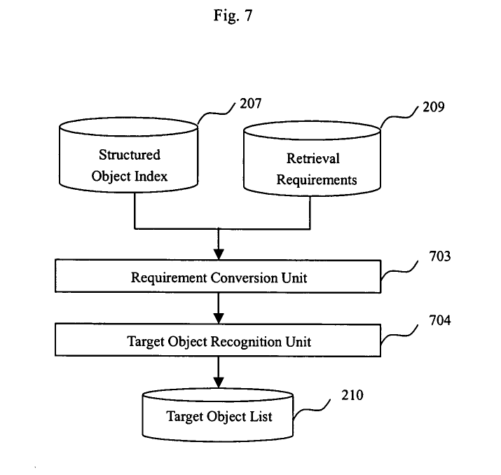

FIG. 7 shows the key steps of Retrieving a Target Object with the object index. The input is a Structured Object Index such as an XML Format Object Index and a Retrieval Requirement 209 such as a Keyword. The Requirement Conversion Unit 703 converts the input Retrieval Requirement into another format—for example, searching a dictionary for words related to the input keyword. The Target Object Recognition Unit 704 determines whether an object is a target object or not. The result is recorded in the Target Object List 705 and is returned to the user.

As the invention has been described in term of preferred embodiments, it is to be appreciated that the invention is not limited to the preferred embodiments. The apparatus and method of the invention can be applied to all kinds of structured documents, including but not limited to web pages and XML files, and can be used to retrieve all kinds of multimedia objects, including but not limited to images, animations, audio, video, and tables.

Although a few embodiments of the present invention have been shown and described, it would be appreciated by those skilled in the art that changes may be made in these embodiments without departing from the principles and spirit of the invention, the scope of which is defined in the claims and their equivalents.

1. A multimedia object retrieval apparatus for retrieving multimedia objects from structured documents containing both a multimedia object and relevant explanation text, comprising:
a parsing unit which parses an input structured document into a parsing result having a first form;
a main block recognition unit which recognizes a main block in the parsing result and outputs a structured document model having a second form;
an object explanation extraction unit which processes the structured document model, and outputs a structured object index having a third form; and
a multimedia object retrieval unit which searches through the structured object index, and forms a target object list.

2. The multimedia object retrieval apparatus according to claim 1, further comprising a main text block recognition unit which removes redundant information from the parsing result, recognizes a main text block in the parsing result, and outputs a main text annotated structured document model to the multimedia object retrieval unit.

3. The multimedia object retrieval apparatus according to claim 1, further comprising a repeating object block recognition unit which searches the parsing result for a repeating object block with a repeating object pattern recognition rule, and outputs a repeating object annotated structured document model.

4. The multimedia object retrieval apparatus according to claim 1, further comprising a common explanation extraction unit which extracts a common explanation for each multimedia object in respective main blocks with a common explanation extraction rule.

5. The multimedia object retrieval apparatus according to claim 1, further comprising an object/explanation pair reorganization unit which extracts at least one pair of an object and an explanation from the structured document model.

6. The multimedia object retrieval apparatus according to claim 1, further comprising an object filtering unit which removes at least one invalid object using at least one keyword in at least one explanation field,
wherein any remaining object is extracted by the object explanation extraction unit.

7. The multimedia object retrieval apparatus according to claim 1, further comprising a keyword extraction unit which analyzes the explanation text for the multimedia object, extracts a keyword corresponding to the multimedia object, and cancels an invalid explanation text, using a rule for analyzing an actual explanation keyword.

8. A multimedia object retrieval method for retrieving multimedia objects from structured documents containing both a multimedia object and relevant explanation text at the same time, comprising:
parsing an input structured document into a parsing result having a first form;
recognizing a main block in the parsing result and outputting a structured document model having a second form;
processing the structured document model, and outputting a structured object index having a third form; and
searching through the structured object index and forming a target object list.

9. The method according to claim 8, further comprising removing redundant information from the parsing result, recognizing a main text block in the parsing result, and outputting a main text annotated structured document model,
wherein the main block includes the main text block.

10. The method according to claim 8, further comprising searching the parsing result for a repeating object block with a predetermined repeating object pattern recognition rule, and outputting a repeating object annotated structured document model.

11. The method according to claim 8, further comprising extracting a common explanation for each multimedia object in a corresponding respective main block with a common explanation extraction rule.

12. The method according to claim 8, further comprising removing an invalid object using a keyword in an explanation field.

13. The method according to claim 8, further comprising extracting a pair of an object and a corresponding explanation text from the structured document model.

14. The method according to claim 8, further comprising analyzing the explanation text for the multimedia object, extracting a keyword corresponding to the multimedia object, and cancelling an invalid explanation, using a rule for analyzing an actual explanation keyword.

15. A multimedia object retrieval apparatus for retrieving multimedia objects from structured documents containing both a multimedia object and relevant explanation text, comprising:
parsing means for parsing an input structured document into a parsing result having a first form;
main block recognition means for recognizing a main block in the parsing result and outputting a structured document model having a second form;
object explanation extraction means for processing the structured document model, and outputting a structured object index having a third form; and
multimedia object retrieval means for searching through the structured object index, and forming a target object list.
